(19) United States
(12) Patent Application Publication
(10) Pub. No.: US 2005/0039781 A1
(43) Pub. Date: Feb. 24, 2005

(54) Dispensing device for liquid detergent compositions

(75) Inventors: Brian Xiaoqing Song, West Chester, OH (US); Gillian Margaret Hardy, Newcastle upon Tyne (GB)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/686,140

(22) Filed: Oct. 15, 2003

Related U.S. Application Data
(60) Provisional application No. 60/423,300, filed on Nov. 1, 2002.

(51) Int. Cl. B08B 3/00

(52) U.S. Cl. 134/43

(57) ABSTRACT

A liquid-permeable dispensing device having a hollow body, a base, and a liquid-permeable sidewall to substantially retain a liquid detergent composition until the operation of the wash cycle of an automatic dishwashing appliance.

### CROSS REFERENCE TO RELATED APPLICATION

This application claims the benefit of the filing date of U.S. Patent Application No. 60/423,300, filed Nov. 1, 2002.

### FIELD OF INVENTION

A liquid-permeable dispensing device for accommodating a liquid detergent composition is provided which is designed to be placed in an automatic dishwashing appliance.

### BACKGROUND OF THE INVENTION

The advent of high performance dishwashing products, stimulated in part by increased aesthetic and sanitary standards and a demand for shorter wash times has generally been characterized by the development of more complex detergent compositions, which are more hazardous to the consumer, less stable, and more difficult to dissolve in a satisfactorily uniform manner. The availability of high performance products has led to many different methods for dispensing detergent compositions.

One approach to dispensing detergent compositions in conventional domestic, industrial and institutional automatic dishwashing appliances is to add the detergent composition to the wash tank by means of an automatic dispenser system. The term “automatic dispenser” with respect to automatic dishwashing appliances has been generally used to describe a built-in device that is used to store and release detergent compositions at a preset time during the wash cycle or immediately during the prewash cycle prior to the wash cycle of the automatic dishwashing appliance. The automatic dispensing devices are generally designed to hold a measured quantity or dose of the detergent composition. The automatic dispensing system can generally be designed to dispense all forms of detergent compositions.

Another approach to dispensing detergent compositions in automatic dishwashing appliances is to provide a solid cast detergent-containing article wherein a liquid detergent composition is cast into a mold where it is allowed to solidify. The solid cast detergent-containing article is placed in the automatic dishwashing appliance wherein an impinging liquid spray dissolves the solid cast detergent to form a liquid aqueous detergent composition, which is simultaneously formed in and released from the dispensing article to the wash tank.

Another approach to dispensing liquid detergent compositions or cake detergent compositions is via a liquid dispenser, such as a showerhead, where water is passed through the housing where a solid detergent cake is stored, and the housing is oriented so as to drain through an aperture to the outlet of the dispensing device.

Another approach to dispensing a liquid detergent composition in automatic dishwashing appliances is to provide an unattached, freestanding dispensing device that is placed inside the appliance during operation.

One problem associated with dispensing the more complex detergent compositions is related to differential solubility of the detergent components. Not all of the components of liquid or gel detergents dissolve at the same rate or have the same equilibrium solubilities. Often this leads to incomplete delivery of the detergent composition to the wash tank, leaving the less soluble residues in the dispensing device itself while delivering the more soluble components to the wash tank.

Thickened liquid detergent compositions in the form of highly viscous liquids, liquid gels or gels offer enhanced phase stability and solubility in automatic dishwashing applications. They also provide for improved dispensing of the product from its container to the dispensing device. The problem with current dispensing devices, be they automatic or freestanding, is that the dispensing device design does not for allow optimum delivery of highly viscous liquid, liquid gel or gel detergent compositions to the wash tank during the wash cycle of the automatic dishwashing appliance. When used in such dispensing devices, the highly viscous liquid, liquid gel or gel detergent compositions often tend to remain as residues in the dispensing device well after the optimum delivery time, and many times the residues are not delivered to the wash tank at all. This residue problem is inefficient, a cleanup nuisance and has a negative aesthetic impact on the consumer, who sees detergent residues as an indicator of an incomplete washing cycle.

Alternatively, when used in such dispensing devices, a less viscous liquid or gel detergent composition or product often dissolves prematurely during the prewash cycle, which is often shorter and colder than wash cycles in most automatic dishwashing appliances. Thus, a less viscous liquid or gel detergent composition or product which is dispensed in the prewash cycle would be pumped out of the automatic dishwashing appliance before it has a chance to work.

Some dispensing devices may occasionally become detached from and overturned in the interior of the automatic dishwashing appliance during the wash cycle of this machine. This may occur during the wash cycle due to external forces acting on the dispensing device. These forces may, for example, be due to the circulation of water and/or of air inside the automatic dishwashing appliance during the wash cycle. Dishes and/or cutlery may also inadvertently move inside the automatic dishwashing appliance during the wash cycle and cause the detachment of the dispensing device. The contents of the dispensing device will escape if the dispensing device substantially deviates from its upright position leading to inefficient timing in the delivery of highly viscous liquids, liquid gels or gel detergent compositions. Furthermore, the dispensing device may melt if it falls on the heating elements during operation of the automatic dishwashing appliance if the dispensing device is detached or disengaged from its point of attachment.

When dispensing highly viscous liquids, liquid gels or gel detergent compositions in an automatic dishwashing appliance, the premature product dissolution, the product residue and the detachment problems can be reduced or eliminated by using a liquid-permeable dispensing device for accommodating and substantially releasing a measured unit dose during the wash cycle. The liquid-permeable dispensing device provided herein may be a hollow body container having a base, a sidewall, a holding element, and optionally a securing element.

### REFERENCES

Background references include: U.S. Pat. No. Re. 32,763; U.S. Pat. No. 2,920,417; U.S. Pat. No. 3,323,543; U.S. Pat. No. 3,399,813; U.S. Pat. No. 3,980,206; U.S. Pat. No. 3,426,688; U.S. Pat. No. 4,190,181; U.S. Pat. No. 4,294,280; U.S. Pat. No. 4,350,666; U.S. Pat. No. 4,545,917; U.S. Pat. No. 5,186,912; U.S. Pat. No. 6,048,501; PCT Patent Publications WO 02/068352 A2 and WO 02/076278 A2; and U.S. Patent Application No. 2002/0108969 A1.

### SUMMARY OF THE INVENTION

A liquid-permeable dispensing device for accommodating a liquid detergent composition is provided which is designed to be placed in an automatic dishwashing appliance. One embodiment of the dispensing device comprises a hollow body, a base, a sidewall, a holding element, and optionally a securing element, wherein the sidewall is liquid permeable, and wherein a unit dose of a highly viscous liquid, liquid gel or gel detergent composition is dispensed during the wash cycle.

The liquid-permeable dispensing device may be adapted to retain a unit dose of a highly viscous liquid, liquid gel or gel detergent composition throughout the prewash cycle and dispense the composition during the wash cycle of an automatic dishwashing appliance. The dispensing device may be a rigid structure comprising a hollow body having at least one opening to allow the introduction of a liquid detergent composition into the dispensing device, a base to cradle the liquid detergent composition, and a liquid-permeable sidewall to allow the discharge of the liquid detergent composition from the dispensing device. The dispensing device may comprise at least one holding element, which allows the consumer to attach the dispensing device to the interior of an automatic dishwashing appliance to ensure that the dispensing device substantially maintains the upright position throughout the wash cycle. The dispensing device may further may comprise an optional securing element, which may prevent the dispensing device from being detached during the wash and/or rinse cycle.

The combination of a liquid-permeable dispensing device and a liquid detergent composition is disclosed herein. In addition, a method, and a kit are also disclosed herein.

### BRIEF DESCRIPTION OF THE FIGURES

FIG. 1 is a perspective view of an embodiment of the dispensing device.

FIG. 2 is a top view of another embodiment of the dispensing device, similar to the dispensing device in FIG. 1, but having a hole in the holding element.

FIG. 3 is a front view of another embodiment of the dispensing device of the device.

FIG. 4 is a perspective view of the embodiment of the dispensing device in FIG. 3 having a holding element and an optional securing element.

FIG. 5a is a cross-sectional view of the embodiment of the dispensing device shown in FIG. 2 taken along line 5a-5a.

FIG. 5b is a cross-sectional view, similar to that of FIG. 5a, of another embodiment of the dispensing device.

FIG. 5c is a cross-sectional view of another embodiment of the dispensing device.

FIG. 5d is a cross-sectional view of another embodiment of the dispensing device.

FIG. 5e is a cross-sectional view of another embodiment of the dispensing device.

FIG. 5f is a cross-sectional view of another embodiment of the dispensing device.

FIG. 6 is a cross-sectional view of the embodiment of the dispensing device in FIG. 3 taken along line 6-6.

### DEFINITIONS

As used herein, the term “liquid detergent composition” refers to any form of liquid detergent composition including, but not limited to, highly viscous liquids, liquid-gels, gels, and mixtures thereof. Liquid detergent compositions may be prepared by any method known in the art, and may comprise any and all ingredients known in the automatic dishwashing detergent art. Such ingredients may include, but are not limited to, surfactants, suds suppressers, bleaches, chelants, builders, enzymes, fillers and perfumes. The liquid detergent compositions that can be used with the dispensing device described herein may comprise any formulations, and are not limited to high performance formulations or those having complex dishwashing product formulations.

As used herein, the term “prewash cycle” refers to the cold-water wash that occurs prior to the hot-water wash of an automatic dishwashing appliance and is not to be considered equivalent to the wash cycle. Though the prewash cycle may be offered as part of the initial wash cycle in some automatic dishwashing appliances, the distinction, disclosed herein, between the prewash and wash cycles, however, relates to the water temperatures of the two washes (i.e. cold vs. hot) and the fact that the prewash cycle occurs prior to the wash cycle.

As used herein, the terms “substantial loss” refers to the premature loss of the liquid detergent composition from the dispensing device by gravity flow or by dissolution under cold-water prewash cycle forces such that a substantial portion of the unit dose of the liquid detergent composition is delivered prior to the wash cycle. In other words, “substantial loss” means that an effective amount of the liquid detergent composition may “substantially escape” from the dispensing device by gravity flow or by dissolution under cold-water prewash cycle forces so that the amount delivered by dissolution during the operation of the automatic dishwashing appliance in the wash cycle is less effective in treating soiled dishware efficiently. The term “substantially escape” means that about 50%, by weight, of the liquid detergent composition will be lost once the liquid detergent composition is placed in the dispensing device and filled to the proper unit dose level disclosed below. In some embodiments, it may be desirable that no more than about 40%, no more than about 30%, no more than about 20%, no more than about 10%, no more than about 1%, or no more than about 0%, by weight, of the liquid detergent composition will substantially escape once a unit dose of the liquid detergent composition is placed in the dispensing device for a specific period of time.

Conversely, the dispensing device described herein is designed to “substantially retain” the unit dose of the liquid detergent composition so that it is substantially delivered during the wash cycle and not the cold-water prewash cycle. The term “substantially retain” means that the dispensing device described herein is designed to cradle or hold at least about 50%, by weight, of the liquid detergent composition contained therein prior to the start of the wash cycle of an automatic dishwashing appliance. The dispensing device may also be designed to hold at least about 60%, at least about 70%, at least about 80%, at least about 90% at least about 99%, or about 100%, by weight, of the liquid detergent composition contained therein prior to the start of the wash cycle of an automatic dishwashing appliance.

### DETAILED DESCRIPTION OF THE INVENTION

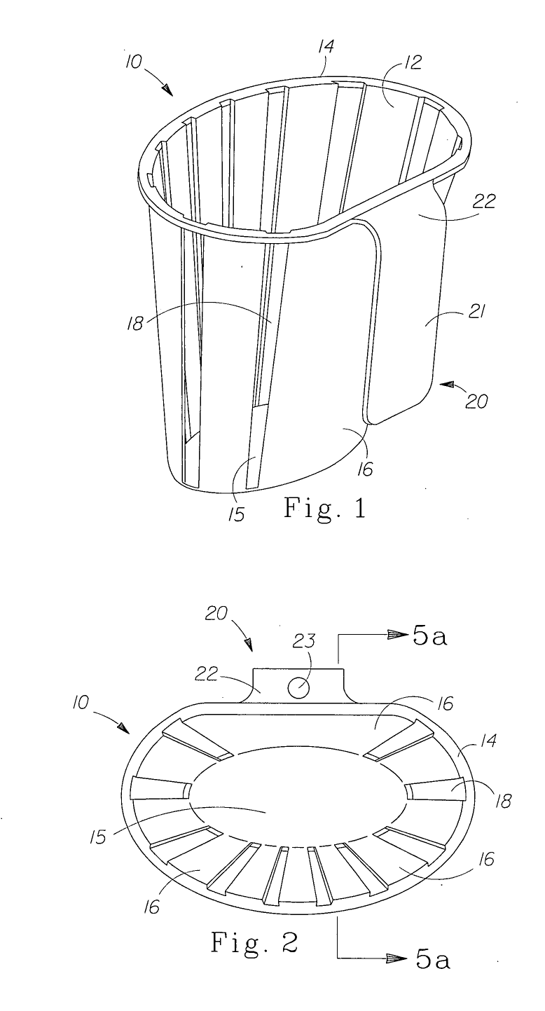

FIG. 1 shows an embodiment wherein the dispensing device 10 may comprise a hollow body 12. The hollow body 12 of the dispensing device 10 may be of any shape such that it can readily accommodate the liquid detergent composition. The hollow body 12 may have any suitable cross-sectional shape. Such shapes include, but are not limited to, a trapezoid, square, ellipse, rectangular, circle, and combinations thereof. For example, another embodiment may provide a hollow body 12 that is enfigured to fit in the rack or cutlery basket of a typical automatic dishwashing appliance.

The dispensing device 10 may be made of any suitable material by any suitable process. The dispensing device 10 may be formed from any water resistant material that can withstand moderately elevated temperatures, such as those reached in automatic dishwashing appliances, e.g. about 65° C., for a relatively long period of time (about 3 hours) and which can be formed into the desired shape. In one embodiment, the dispensing device 10 may be made of low cost thermoplastic material such as polypropylene and formed by injection molding.

The hollow body 12 may comprise at least one opening 14, a base 15 and a liquid-permeable sidewall 16. The dispensing device 10 may comprise more one or more hollow body 12, opening 14, base 15, liquid-permeable sidewall 16, and combinations thereof. In fact, the dispensing device may also comprise a top or covering element which may or may not be liquid-permeable but will aid in the dispensing of the liquid detergent device, improve aesthetics, provide for child-proofing and safety, or for any other purpose.

The opening 14 of the hollow body 12 may allow filling and/or refilling of the dispensing device 10 by the consumer, and may, therefore, comprise a filling means. The filling means may comprise any shape, design and/or dimension of the opening 14 so that the liquid detergent composition can be readily poured into the dispensing device 10 through the opening 14 while positioned either outside or inside the automatic dishwashing appliance. The shape, design configuration and dimensions of the dispensing device 10 may be adapted to retain the liquid detergent composition for a specific time interval or period or until the proper time of delivery is achieved, for example, during the wash cycle.

In certain embodiments, the liquid detergent composition contained in the dispensing device 10 can be dissolved during a wash cycle, for example, by water. The dissolved liquid detergent composition is able to enter and/or exit the liquid-permeable dispensing device 10 via at least one orifice 18, located on the sidewall 16 or base 15. The amount and/or rate at which the dissolved liquid detergent composition is released during the wash cycle of the automatic dishwashing appliance to treat dishware is determined by the size and shape of the dispensing device 10, opening 14, base 15, sidewall 16, and/or at least one orifice 18. Thus, the size, shape and dimensions of the dispensing device 10, opening 14, base 15, sidewall 16, and/or at least one orifice 18 comprise a dispensing means to allowing water to enter and/or exit the dispensing device 10 so that the liquid detergent composition is dissolved and is dispensed as a dissolved liquid detergent composition during the wash cycle.

Thus, the dispensing means allows water to enter and exit, to dissolve said liquid detergent composition, and to deliver said dissolved liquid detergent composition during the wash cycle of said appliance instead of during the prewash cycle. The dispensing device 10, however, may also be designed so that the liquid detergent composition does not have to be dissolved prior to being dispensed in either the prewash cycle or the wash cycle.

The embodiment of FIGS. 1 and 2 show that the hollow body 12 of the dispensing device 10 may comprise a rigid frame having a base 15 and a perforated sidewall 16. The hollow body 12 may have a structure capable of holding the liquid detergent composition while resisting the forces of the washing environment inside the automatic dishwashing appliance. The sidewall 16 may be substantially perpendicular to the base or at an angle to the base 15. The opening 14 may be opposite to the base 15. In fact, there may one or more openings 14 in the dispensing device 10, each optionally oriented differently with respect to each other.

FIG. 2, a top view of FIG. 1, shows a holding element 20 optionally having at least one hole 23 through which a vertical rack member of a dishwashing appliance rack can be placed. Many automatic dishwashing appliances provide a rack with its vertical rack members attached only on one side (i.e. the vertical rack member is attached to the bottom horizontal rack members of the rack itself). The at least one hole 23 may be located anywhere on the holding element 20, to accept the vertical rack member. For example, the upper portion of a vertical rack member may be positioned through the at least one hole 23 of the holding element 20, to attach the dispensing device 10 to the rack in a way in which horizontal movement of the dispensing device 10 is minimized. That is, the vertical rack member may act as a bayonet to hold the dispensing device 10 upright. In fact, the at least one hole 23 is not limited to being provided in on the holding element 20, rather the at least one hole 23 may be provided on any surface or component of the dispensing device 10 itself. Thus, the at least one hole 23 that is engaged to a vertical rack member, as disclosed above, may also act as an attaching means.

The base 15 may be closed, or it may have one or more openings therein. In certain embodiments, the base 15 is closed in order to aid in retaining the liquid detergent composition until proper time of delivery is achieved. That is, a base 15 that is closed is liquid impermeable. As such, a base 15 that is free of perforations acts to retard gravity delivery of the liquid detergent composition from the dispensing device 10 by cradling the liquid detergent composition prior to the start of the wash cycle of the automatic dishwashing appliance without substantial loss or escape of the liquid detergent composition after filling. Furthermore, a base 15 that is closed can also act to minimize liquid detergent composition dissolution from the forces of the cold-water spray during the prewash cycle. Alternatively, the base 15 can be perforated with one or more openings which are small enough to substantially retain the unit dose of the liquid detergent composition in the dispensing device 10 for a specific period of time after filling yet allow entry of the hot wash water so that it may dissolve the liquid detergent composition for dispensing during the wash cycle of the automatic dishwashing appliance, or alternatively, act as a exit conduit for dispensing the dissolved liquid detergent composition during the wash cycle.

The liquid-permeable sidewall 16 may comprise any suitable type of structure; for instance, it may be a ribbed cage or a mesh or a perforated sheet structure. The liquid-permeable sidewall 16 may have at least one orifice 18, and may in fact have multiple orifices 18. For a liquid-permeable dispensing device 10 having more than one orifice 18, the multiple orifices 18 may be distributed throughout the hollow body 12 of the dispensing device 10 in any manner or spatial arrangement. The dimensions of the at least one orifice 18 may be provided such that at least about 50%, by weight, of the liquid detergent composition will not substantially escape through the at least one orifice 18 of the dispensing device 10 when placed in the dispensing device 10 for between from about one minute to about 30 minutes, or between from about one minute to about one hour, or between about one minute to about four hours, or between from about one minute to about twenty-four hours prior to operation of the automatic dishwashing appliance. In certain other embodiments, at least about 60%, at least about 70%, at least about 80%, at least about 90%, at least about 99%, or about 100%, by weight, of the liquid detergent composition will not substantially escape through the at least one orifice 18 of the dispensing device 10 when placed in the dispensing device 10 for the same time intervals.

The opening 14 and/or at least one orifice 18 in the sidewall 16 may be in any shape that is effective in allowing water to enter and/or exit the dispensing device 10. For example, the individual shape of the opening 14 and/or at least one orifice 18 may be a trapezoid, square, ellipse, rectangular, circle, and combinations thereof. The at least one orifice 18 may be located anywhere on the sidewall 16 of the dispensing device 10. In another embodiment, the at least one orifice 18 may run up to about or just above the unit dose fill line 40 of the sidewall 16 or higher. In yet another embodiment, the at least one orifice 18 may run from the base 15 up to about the full length of the sidewall 16.

The shape of the opening 14 and/or the at least one orifice 18 in the sidewall 16 are also designed to minimize escape or release of the liquid detergent composition from the dispensing device 10 when filled to the unit dose fill line 40, prior to the point in which the liquid detergent composition is designed to be dispensed. In certain embodiments, at least about 50%, by weight, of the liquid detergent composition remains in the dispensing device 10 when subjected to gravity or to the forces of a cold-water prewash cycle during operation of the automatic dishwashing appliance. In certain other embodiments, at least about 60%, at least about 70%, at least about 80%, at least about 90%, at least about 99%, or about 100%, by weight, of the liquid detergent composition remains in the dispensing device 10 when subjected to gravity or to the forces of a cold-water prewash cycle during operation of the automatic dishwashing appliance. In other embodiments, however, the dispensing device 10 can be designed so that the liquid detergent composition may be dispensed during the cold-water prewash cycle.

Nevertheless in certain embodiments, the shape and dimension of the opening 14 and/or at least one orifice 18 are designed to allow water to enter and/or exit the dispensing device 10 for the purpose of substantially dissolving at least about 50%, by weight, of the liquid detergent composition during the wash cycle of the automatic dishwashing appliance, thus making the dispensing device 10 liquid-permeable, and functionally providing a dispensing means. In certain other embodiments, the shape of the opening 14 and/or at least one orifice 18 in the sidewall 16 are designed to allow at least about 60%, at least about 70%, at least about 80%, at least about 90%, at least about 99%, or about 100%, by weight, of the liquid detergent composition to be substantially dissolved during the wash cycle of the automatic dishwashing appliance.

Furthermore, the shape of the opening 14 and/or the at least one orifice 18 are also designed to minimize undissolved liquid detergent composition residues from remaining in the dispensing device 10 after the wash cycle. In certain embodiments after the wash cycle, less than about 10%, by weight, of liquid detergent composition residues will remain in a liquid-permeable dispensing device 10 after completion of the wash cycle when filled to the proper level prior to the operation of the automatic dishwashing appliance. In certain other embodiments, less than about 5%, less than about 3%, less than about 1%, or less than about 0%, by weight, of liquid detergent composition residues will remain in a liquid-permeable dispensing device 10 after completion of the wash cycle when filled to the proper level prior to the operation of the automatic dishwashing appliance.

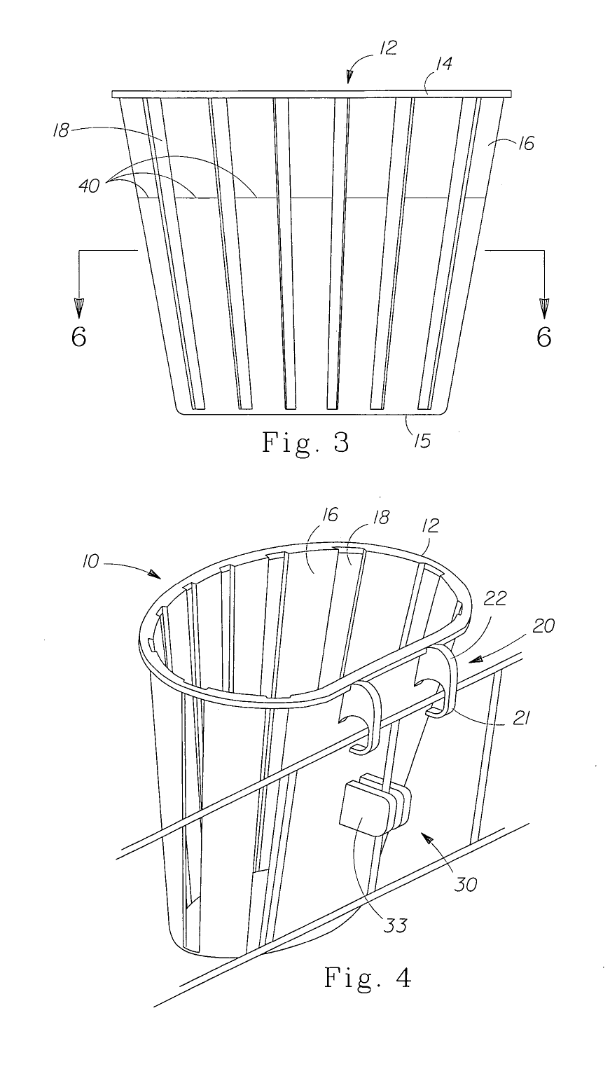

FIG. 3 shows another embodiment of a dispensing device 10 comprising a fill line 40 that may be delineated in any suitable manner, including but not limited to, a marking, raised line, indented line, and combinations thereof provided on the dispensing device 10. The unit dose fill line 40 may be located on the outside face of the sidewall 16, on the inside face of the sidewall 16 within the hollow body 12, provided inside the sidewall 16 itself, or a combination of the above. For example, a color change having a raised surface in the form of a line at the location of the unit dose fill line 40 could indicate to the consumer the proper fill level of the unit dose.

The shape and size of the opening 14 and the number of the at least one orifice 18 may be determined by the shape of the dispensing device 10; the available space on the sidewall 16; by how much liquid detergent composition is allowed to be exposed to water once inside the automatic dishwashing appliance; by how much dissolved liquid detergent composition is discharged from the at least one orifice 18 during the wash cycle; by the viscosity of the liquid detergent composition; by any other function or relationship related to the release of the liquid detergent composition and the effective treatment of dishware; and combinations thereof.

The at least one orifice 18 may be of any suitable dimension or dimensions. If in circular form, the diameter of the at least one orifice 18 may, for example, vary between from about 0.5 mm to about 10 mm, between from about 1 mm to about 8 mm, or between from about 2 mm to about 6 mm. The dimensions of a square or rectangular orifice 18 may, for example, vary between from about 0.5 mm to about 10 mm, between from about 1 mm to about 8 mm, or between from about 2 mm to about 6 mm in width and between from about 0.5 mm to about the full length of the sidewall 16 in length.

The dispensing device 10 may comprise at least one holding element 20. As used herein, the term “holding element” refers to any element, which can be adapted to attach and/or to hold the dispensing device to the interior of an automatic dishwashing appliance so that it can be accessed and/or released therefrom when required by the consumer. The holding element 20 may be made of any suitable material. The holding element 20 may be made of similar or identical material to that of the dispensing device 10 itself. The holding element 20 may be located anywhere on the dispensing device 10, including but not limited to on the sidewall 16 or base 15 of the dispensing device 10. The holding element 20 may be provided in any shape that can attach the dispensing device 10 to the inside of an automatic dishwashing appliance.

The holding element 20 may allow the dispensing device 10 to be attached or held to the inside of an automatic dishwashing appliance and may, therefore, comprise an attaching means. The attaching means allows the consumer to place the dispensing device 10 substantially upright inside the automatic dishwashing appliance so that it remains substantially vertical to prevent loss or escape of the liquid detergent composition when filled to the unit dose fill line 40. The attaching means is accomplished by any reasonable means that includes, structural means, such as for example, through the use of a hook, the shape of the dispensing device 10, and combinations thereof. The holding element 20 may be adapted to allow the dispensing device 10 to be attached substantially vertical in the upright position to the rack or cutlery basket in the interior of an automatic dishwashing appliance by using a hook to aid in its retention of a liquid detergent composition when filled to the unit dose fill line 40.

FIG. 1 shows an embodiment of a holding element 20 which comprises at least a proximal portion or leg 22 attached to at least one distal portion or leg 21, wherein the at least one proximal leg 22 is attached to and extends from the sidewall 16. The legs of the holding element 20 may have any suitable shape or dimension. The length and width of the at least one distal leg 21 and shorter proximal leg 22 are designed to allow the dispensing device 10 to be attached to the inside of an automatic dishwashing appliance. The holding element 20 may be located anywhere on the dispensing device 10, including the base 15 and the sidewall 16. For example, the holding element 20 may be located from about 0 mm to about 15 mm from the opening 14 and/or the base 15 on the sidewall 16, as illustrated for example in FIG. 1.

FIG. 4 shows that the holding element 20 may take the shape of a hook having any suitable size or dimension. That is, the at least one distal leg 21 may be oriented at any angle with respect to the face of the sidewall 16, for instance, the distal leg may be substantially parallel to, substantially perpendicular to, and combinations thereof to the face of the sidewall 16. The at least one proximal leg 22 may be similarly attached to the face of the sidewall 16. For example, the at least one proximal leg 22 may be attached substantially parallel to, substantially perpendicular to, and combinations thereof to the face of the sidewall 16.

In one embodiment, the holding element 20 may be pointing downward towards the base 15. The dimensions of the at least one proximal leg 22 may, for example, vary between from about 3 mm to 50 mm of length and from about 1 mm to about 25 mm in width. The at least one distal leg may, for example, also vary between from about 5 mm to 200 mm in length and from about 1 mm to about 25 mm in width. In another example, the dimensions of the at least one distal leg 22 of the holding element 20 may be greater than or equal to about 20 mm of length and greater than or equal to about 5 mm in width while the at least one proximal leg 22 may be greater than or equal to about 5 mm in both length and width.

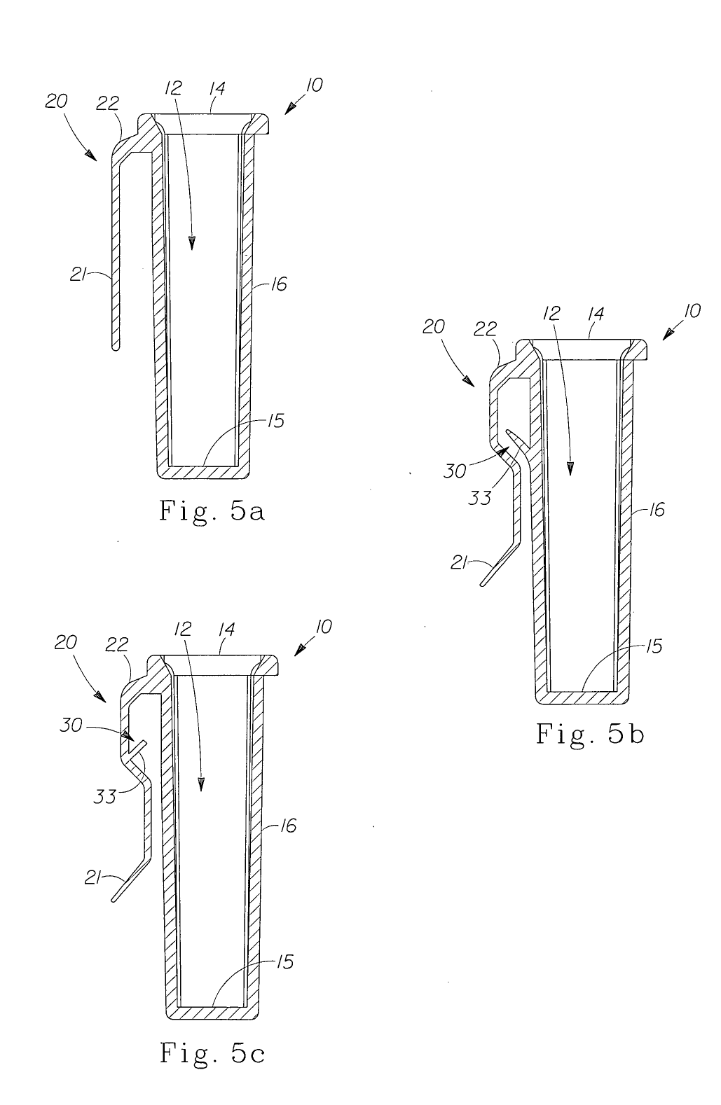

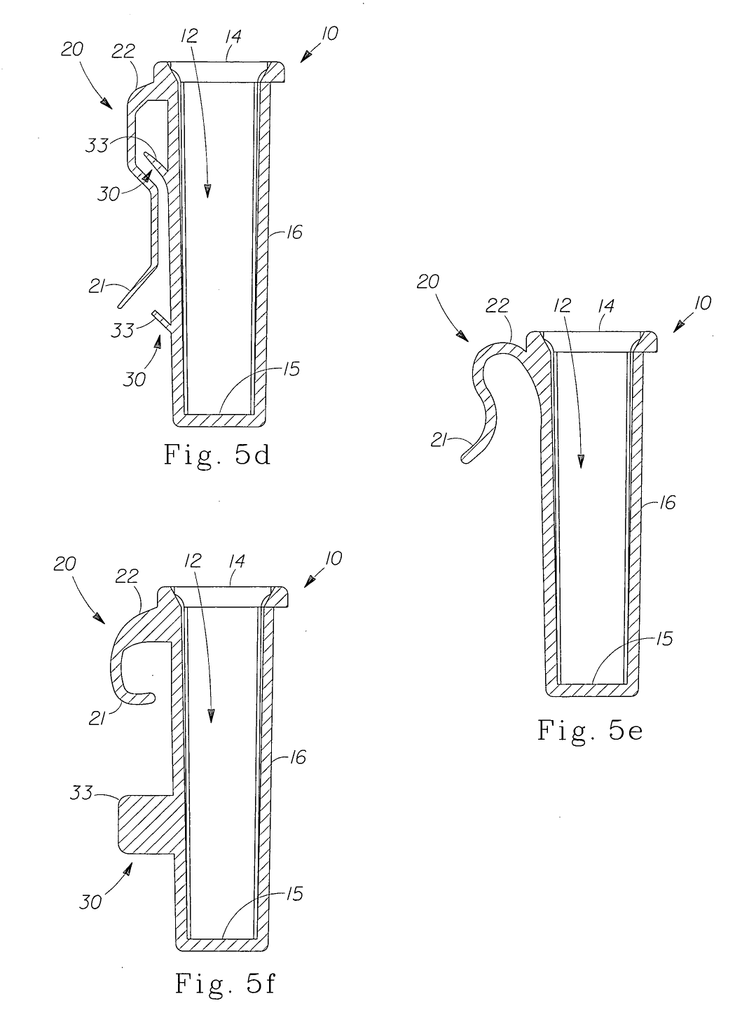

In FIGS. 5a and 5e, certain embodiments show that holding element 20 may be adapted for attachment to the rack or cutlery basket of an automatic dishwashing appliance, such as on a top or bottom, horizontal or vertical, rack member or cutlery basket. In certain embodiments, a liquid-permeable dispensing device 10 may comprise two or more holding elements, for example, pointing in opposed directions, or, positioned at ninety degrees to each other for placement in the corner of the rack.

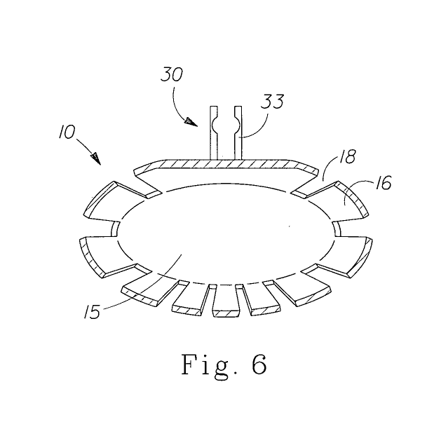

FIGS. 3, 4, and 6, show one embodiment that provides an optional securing element 30 in addition to the holding element 20. The securing element 30 may be adapted to secure (i.e. fasten or clip) the dispensing device 10 to the rack or cutlery basket of an automatic dishwashing appliance. In this case, the securing element 30 may comprise two arms 33, which extend outward from the sidewall 16 and are located directed below the holding element 20. As used herein, unlike the “holding element” that allows the consumer to attach the dispensing device 10 to the interior of an automatic dishwashing appliance, the term “securing element” refers to any element which can be adapted to secure the dispensing device to the interior of an automatic dishwashing appliance so that it cannot be disengaged therefrom during the wash cycle of the automatic dishwashing appliance without being intentionally released by the consumer.

The securing element 30 may secure the dispensing device 10 onto the rack or cutlery basket of an automatic dishwashing appliance, and may, therefore, comprise a securing means. The securing means restrains the dispensing device 10 to the inside of the automatic dishwashing appliance (i.e. rack and/or cutlery basket) by friction, fasteners, clips, by a lock and key-type mechanism, by any other means of securing the device, or combinations thereof. The securing element 30 may be adapted to prevent disengagement of the dispensing device 10, due to child tampering and/or the forces of overfilling, rack movement, and/or those occurring inside an automatic dishwashing appliance during operation, such as the forces exerted by the circulation of water and/or air. The securing element 30 may, for example, aid in making the dispensing device 10 child-resistant when not attended to by an adult. To guard against unwanted removal of the dispensing device 10 by a child, especially a device filled with the liquid detergent composition, the securing element 30 may be designed so that it resists tampering but at the same time can be accessed and released (i.e. unfastened, unclipped, etc.) by the consumer when necessary or required.

The securing element 30 may be of any suitable size, shape, dimension or dimensions. For example, the dimensions of a rectangular securing element 30 may be between from about 1 mm to 100 mm of length and from about 1 mm to 20 mm in width. In another example, the dimensions of a rectangular securing element 30 may be between from about 1 mm and 20 mm in length and from about 1 mm and 15 mm in width. An example of a rod-shape securing element may be between from about 3 to about 30 mm in length and from about 1 mm to about 10 mm in diameter.

FIGS. 5b, 5c, 5d, and 5f show certain embodiments of a securing element 30 that may comprise at least one arm 33. One or more arms 33 may point together towards the same direction, upwards or downwards, in an opposed direction, or in perpendicular directions. For example, the securing element 30 may be in the form of a clip comprising an arm 33 selected from the group consisting of straight, inclined, curved, and combinations thereof. Nevertheless, the securing element 30 does not impede the release of the liquid detergent composition from the dispensing device 10 when placed in the interior of an automatic dishwashing appliance. The securing element 30 may be made of similar or identical material as the dispensing device 10, and may optionally be more rigid or more flexible with respect to the dispensing device 10 itself depending on the need. Other flexible material, formed from metals and/or other materials, may be also considered for the purpose of another embodiment.

The securing element 30 may prevent disengagement of the dispensing device 10 by wash water forces and may be located on any surface of the dispensing device 10 including but not limited to the sidewall 16, base 15, holding element 20, and combinations thereof. Thus, the securing element 30 may secure the dispensing device 10 in any direction with respect to the orientation of any component of the dispensing device 10. For example, the securing element 30 may be located on the same or opposite sidewall 16 of the dispensing device 10 on which holding element 20 is located. In another example, the securing element 30 may be designed to secure the dispensing device 10 in a direction, which is opposite to the direction in which the dispensing device 10 is attached with the holding element 20. As herein defined, “upwards” is defined to be pointed towards the upper part of the dispensing device 10, the upper part being defined by the opening 12. On the contrary, “downwards” is in the following defined to be pointed towards the opposed direction with respect to “upwards”, i.e. towards the base 15 opposing the opening.

FIGS. 5b, 5c and 5d show the securing element 30 pointing upward, but in other embodiments the securing element 30 may be pointing downwards.

In one embodiment for reasons of structural integrity, the sidewall 16 may be free of the presence of an orifice 18 in the area where the holding element 20 and/or securing element 30 are located. For example, FIG. 1 shows that in the immediate area of the holding element 20, the sidewall 16 of the dispensing device 10 may be made liquid impermeable (i.e. nonperforated) in order to provide for greater stability, improved rigidity and strength of the dispensing device 10 during the filling of the liquid detergent composition, during dispensing of the liquid detergent composition, and/or for ease of placement of the dispensing device 10 into the automatic dishwashing appliance.

In another embodiment, a liquid-permeable dispensing device for use in an automatic dishwashing appliance, as described above, may comprise: (a) a filling means; (b) a dispensing means; (c) an attaching means; (d) optionally, a securing means; and (e) combinations thereof.

In another embodiment, the liquid-permeable dispensing device may be used in an automatic washing appliance for laundry purposes.

### Method of Use

In one embodiment, a method of treating dishware is disclosed, the method comprising the steps of: (a) providing a liquid-permeable dispensing device 10 for use in an automatic dishwashing appliance comprising a hollow body 12, a base 15, a sidewall 16, a holding element 20, and optionally a securing element 30, the hollow body 12 having at least one opening 14, the sidewall 16 and/or the base 15 having at least one orifice 18; wherein the device is capable of dispensing a dissolved liquid detergent composition into the appliance during the wash cycle; (b) placing, attaching and optionally securing the device into the interior of the appliance; (c) adding to the liquid-permeable dispensing device 10 a unit dose of the liquid detergent composition by filling the device 10 to the unit dose fill line 40; and treating dishware during the wash cycle of the appliance.

In another embodiment, a method of treating dishware is provided which comprises the steps of (a) providing a liquid-permeable dispensing device 10 comprising a hollow body 12, the dispensing device having (i) at least one opening 14 to allow the introduction of the liquid detergent composition into the liquid-permeable dispensing device 10, (ii) a liquid-permeable sidewall 16 to allow the dissolved liquid detergent composition to exit the liquid-permeable device 10, (iii) a holding element 20 which allows a consumer to attach the liquid-permeable dispensing device to the interior of an automatic dishwashing appliance, and (iv) a securing element 30 which allows a consumer to secure the liquid-permeable dispensing device to the interior of an automatic dishwashing appliance; (b) attaching and securing the liquid-permeable dispensing device 10 into the interior of the automatic dishwashing appliance containing dishware in need of treatment; (c) adding a liquid detergent composition to the liquid-permeable dispensing device 10; and (d) treating the dishware during the wash cycle of the automatic dishwashing appliance.

In another embodiment, the method may comprise a method of removing any type of stain from dishware. In one embodiment of the method, the stain may be a tomato stain and the dishware may be made of plastic.

In another embodiment, the liquid-permeable device 10 may be pre-filled with a liquid detergent composition or product prior to being placed in the rack or cutlery basket of the automatic dishwashing appliance. Conversely, another embodiment allows for the liquid-permeable device 10 to be filled in place by the consumer, that is, while it is on the rack.

### Kit

One embodiment relates to a kit for an automatic dishwashing appliance comprising: (a) a package; (b) a liquid-permeable dispensing device 10 comprising a hollow body 12, the hollow body 12 having (i) at least one opening 14 to allow the introduction of the liquid detergent composition into the liquid-permeable dispensing device 10, (ii) a liquid-permeable sidewall 16 to allow the dissolved liquid detergent composition to exit the device, and (iii) a base 15; (c) optionally a replacement liquid-permeable dispensing device 10; (d) optionally a product comprising a liquid detergent composition for dispensing, said product being contained in a pouch, bottle, or other suitable container; and (e) information in association with the package comprising instructions on how to (i) fill a liquid-permeable dispensing device 10 with the optional product; (ii) insert a liquid-permeable dispensing device 10 into the appliance; and (iii) remove a liquid-permeable dispensing device 10 from the appliance; and combinations thereof; wherein the liquid-permeable dispensing device optionally further comprises a means selected from the group consisting of a filling means, a dispensing means, an attaching means, a securing means, and combinations thereof.

In another embodiment, a kit provides a replacement liquid-permeable dispensing device 10, which can be in the form such that once placed inside a dishwashing appliance it provides a controlled release of the product during the wash cycle of the automatic dishwashing appliance.

The foregoing description can be provided to enable any person skilled in the art to make and use the invention, and can be provided in the context of a particular application and its requirements. Various modifications to the embodiments will be readily apparent to those skilled in the art, and the generic principles defined herein can be applied to other embodiments and applications without departing from the spirit and scope of the invention. The possible embodiments of this invention are not intended to be limited to the embodiments shown. Thus, since the following specific embodiments are intended only to exemplify, but in no way limit, the operation of the present invention, the present invention is to be accorded the widest scope consistent with the principles, features and teachings disclosed herein.

It should be understood that every maximum numerical limitation given throughout this specification would include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited are, in relevant part, incorporated herein by reference; the citation of any document can be not to be construed as an admission that it can be prior art with respect to the present invention.

1. A dispensing device comprising a hollow body, a base, and a sidewall to substantially retain a liquid detergent composition until the operation of a wash cycle of an automatic dishwashing appliance; said hollow body having at least one opening to allow the introduction of said liquid detergent composition into said dispensing device; said dispensing device is liquid-permeable.

2. A liquid-permeable dispensing device according to claim 1 wherein said device further comprises a holding element for attaching said device substantially vertical in the upright position in the interior of said appliance such that said device is capable of retaining a unit dose of said liquid detergent composition.

3. A liquid-permeable dispensing device according to claim 1 wherein said device comprises at least one orifice; wherein said at least one orifice is located anywhere on said sidewall and/or said base.

4. A liquid-permeable dispensing device according to claim 3 wherein the dimensions of said at least one orifice are provided so that a unit dose of said liquid detergent composition will not substantially escape through said at least one orifice when said liquid detergent composition is placed in said device for between from about one minute to about twenty-four hours prior to operation of said appliance so that at least about 50%, by weight, of said liquid detergent composition is retained in said device after filling.

5. A liquid-permeable dispensing device according to claim 4 wherein said dimensions of said at least one orifice are provided so that said liquid detergent composition will not substantially escape through said at least one orifice after filling for between from about one minute to about four hours prior to operation of said appliance.

6. A liquid-permeable dispensing device according to claim 5 wherein said dimensions of said at least one orifice are provided so that said liquid detergent composition will not substantially escape through said at least one orifice after filling for between from about one minute to about one hour prior to operation of said appliance.

7. A liquid-permeable dispensing device according to claim 3 wherein said at least one orifice may be in any shape that is effective in allowing water to enter and/or exit said device for the purpose of substantially dissolving and releasing said liquid detergent composition during said wash cycle of said appliance so that less than about 10%, by weight, of said liquid detergent composition is retained in said device as residue after said wash cycle.

8. A liquid-permeable dispensing device according to claim 7 wherein said at least one orifice comprises a shape selected from the group consisting of a trapezoid, square, ellipse, rectangular, circle, and combinations thereof.

9. A liquid-permeable dispensing device according to claim 8 wherein said at least one orifice is square or rectangular having a shape with dimensions between from about 0.5 mm to about 10 mm in width and from about 0.5 mm to about the full length of said sidewall in length.

10. A liquid-permeable dispensing device according to claim 1 wherein said liquid detergent composition does not substantially escape during the prewash cycle of said appliance so that at least about 50%, by weight, of said liquid detergent composition is retained in said device prior to said wash cycle when said device is filled to the unit dose fill line; wherein said liquid detergent composition is dissolved and substantially released from said device so that at least about 50%, by weight, of said liquid detergent composition is dispensed during said wash cycle; and wherein said device is substantially free of residue from said liquid detergent composition so that less than about 10% of said liquid detergent composition remains in said device upon completion of said wash cycle.

11. A liquid-permeable dispensing device according to claim 1 wherein said base is closed, and wherein said sidewall is substantially perpendicular to said base; and wherein said at least one opening is substantially opposite to said base.

12. A liquid-permeable dispensing device according to claim 1 wherein said hollow body comprises a rigid structure capable of holding said liquid detergent composition while resisting the forces of the washing environment inside said appliance.

13. A liquid-permeable dispensing device according to claim 2, wherein said holding element is attached to and extends along a portion of said sidewall.

14. A liquid-permeable dispensing device according to claim 13, wherein said holding element is in the form of a hook comprising at least one proximal leg attached to at least one distal leg, wherein said proximal leg is attached to and extends from said sidewall.

15. A liquid-permeable dispensing device according to claim 1 wherein said liquid-permeable device further comprises a securing element which prevents said device from being detached and/or disengaged during the operation of said appliance.

16. A liquid-permeable dispensing device according to claim 16, wherein said securing element is an integral part of a component of said device, said component is selected from the group consisting of said base, sidewall, holding element, and combinations thereof.

17. A liquid-permeable dispensing device according to claim 16, wherein said securing element extends outward from the face of said component; and wherein said securing element is in the form of a clip comprising an arm selected from the group consisting of straight, inclined, curved, and combinations thereof.

18. A liquid-permeable dispensing device according to claim 1, wherein said device is formed of an injection molded synthetic plastics material.

19. A liquid-permeable dispensing device for use in an automatic dishwashing appliance comprising:
(a) a filling means to allow a liquid detergent composition to be placed in said device;
(b) a dispensing means to allow water to enter and exit, to dissolve said liquid detergent composition, and to deliver said dissolved liquid detergent composition during the wash cycle of said appliance instead of during the prewash cycle;
(c) an attaching means to hold said dispensing device upright so that it is stands substantially vertical when placed inside said appliance;
(d) optionally, a securing means to restrain the dispensing device so that it is not overturned or does not become disengaged prior to and/or during operation of said appliance; and
(e) combinations thereof.

20. A method of treating dishware comprising the steps of:
(a) providing a liquid-permeable dispensing device for use in an automatic dishwashing appliance comprising a hollow body, a base, a sidewall, a holding element, and optionally a securing element, said hollow body having at least one opening, said sidewall and/or said base having at least one orifice; said device capable of dispensing a dissolved liquid detergent composition into said appliance during the wash cycle;
(b) placing, attaching and optionally securing said device into said interior of said appliance;
(c) adding to said device a unit dose of said liquid detergent composition by filling said device to the unit dose fill line; and
(d) treating said dishware during the wash cycle of said automatic dishwashing appliance.

21. A kit for an automatic dishwashing appliance comprising:
(a) a package;
(b) a liquid-permeable dispensing device comprising a hollow body, said hollow body having
(i) at least one opening to allow the introduction of said liquid detergent composition into said liquid-permeable dispensing device,
(ii) a liquid-permeable sidewall to allow said dissolved liquid detergent composition to exit said liquid-permeable device, and
(iii) a base;
(c) optionally a replacement liquid-permeable dispensing device;
(d) optionally a product comprising a liquid detergent composition for dispensing, said product being contained in a pouch, bottle, or other suitable container; and
(e) information in association with said package comprising instructions on how to
(i) fill a liquid-permeable dispensing device with said optional product;
(ii) insert a liquid-permeable dispensing device into the appliance;
(iii) remove a liquid-permeable dispensing device from the appliance; and
(iv) combinations thereof;
wherein said device optionally further comprises a means selected from the group consisting of a filling means, a dispensing means, an attaching means, securing means, and combinations thereof.
